(19) United States
(12) Patent Application Publication
(10) Pub. No.: US 2015/0262089 A1
(43) Pub. Date: Sep. 17, 2015

(54) SYSTEM AND METHOD FOR ONE-CLICK BOOKING OF A SERVICE EVENT FOR A USER

(71) Applicant: Reso Holdings, Inc., San Francisco, CA (US)

(72) Inventors: Adam Hiatt, San Francisco, CA (US); John Paul SHAY, San Francisco, CA (US); Yann SCHWERMER, San Francisco, CA (US); Ben Yaco, San Francisco, CA (US)

(73) Assignee: Reso Holdings, Inc., San Francisco, CA (US)

(21) Appl. No.: 14/206,502

(22) Filed: Mar. 12, 2014

(51) Int. Cl. G06Q 10/02

(52) U.S. Cl. CPC G06Q 10/025; G06Q 10/02

(57) ABSTRACT

A system and method for automated reservation management are provided. For example, automated reservation management may comprise predicting the need for a next service event for a user and a date and time during which the user and a vendor are available for the next service event, providing information related to a potential reservation for the next service event to the user, including the reservation on the calendars of the user and the vendor responsive to acceptance of the reservation from the user, and/or associating payment information with the reservation.

### FIELD OF THE INVENTION

The invention relates to a system and method for automated reservation management, for example, including predicting the need for a next service event for a user and a date and time during which the user and a vendor are available for the next service event, providing information related to a potential reservation for the next service event to the user, including the reservation on the calendars of the user and the vendor responsive to acceptance of the reservation from the user, and/or associating payment information with the reservation.

### BACKGROUND OF THE INVENTION

In many instances, a consumer may engage vendors to provide recurring services for that consumer. For example, a consumer may use various salon services (e.g., haircut, manicure, hair color, and/or other salon services) on a periodic basis. In another example, a consumer may have a recurring standing date to meet family at a restaurant. A consumer may participate in and receive other recurring services as well. The consumer may have to make a reservation for a service event (e.g., a next haircut, a next family dinner, and/or other event in which the consumer receives a service) to receive a recurring service with each consumer vendor. Consumers may have to track for themselves when a next service event (e.g., a next haircut, a next family dinner, a next camp session and/or other service event) is to occur and make reservations for that next service event. To that end, a consumer may have to track service events, determine when a next service event should occur, check the calendar of the consumer, and determine when a next service event could be performed for the consumer. The consumer also may then have to communicate with a vendor for the next service event to determine a date and time at which both the consumer and the vendor are available for the service event.

A consumer making a reservation may have to participate in several steps in order to complete a reservation for a service event from a vendor. For example, a consumer may make a reservation online, may call a vendor for a reservation, may make a reservation for a next service event during a service event at the vendor, may have another consumer make the reservation, and/or may otherwise make a reservation for a service event. Further, a consumer has to provide payment for the service event. The consumer may pay for the service event while making the reservation, provide payment during and/or after the service event, and/or may otherwise provide payment for the service event.

Conventional reservation tools exist, but have various limitations and drawbacks. For example, conventional reservation systems may be limited to allowing consumers to make reservations for a single vendor and providing feedback to the consumer related to a potential next service event. In another example, conventional reservation systems may be limited to allowing a consumer to search a plurality of vendors and make a reservation for a service event from an individual vendor. These and other drawbacks exist.

### SUMMARY OF THE INVENTION

The invention solving these and other drawbacks relates to a system and method for automated reservation management, for example, including predicting the need for a next service event for a user and a date and time during which the user and a vendor are available for the next service event, providing information related to a potential reservation for the next service event to the user, including the reservation on the calendars of the user and the vendor responsive to acceptance of the reservation from the user, and/or associating payment information with the reservation.

As used herein, a vendor may comprise an entity that provides a set of services. An individual service event may comprise a discrete set of services provided from the vendor to a user. Types of service events may, for example, comprise a haircut, a restaurant reservation, a class that includes multiple lessons, and/or other events in which a vendor provides a discrete set of services to a user. The service events that may be reserved via the system are not limited to the examples described herein.

According to an aspect of the invention, the system may determine a need for a next service event for a user. The system may determine the need for the next service event for the user based on the user's calendar, an amount of time since a service event of the same type was included in the user's calendar, or other information. The system may store a list of service events (e.g., priority list or other list), where each service event is associated with a date of the last scheduled service event of similar type, a time interval for a service event type, and/or other information related to a service event. The system may determine a next service event for the user based on the service events list. For example, the system may determine the next service event to be scheduled based on the last scheduled service and time intervals for the service events in the service events list. The system may also determine a next service event based on an indication of a service event type selected by the user.

Responsive to determining a next service event to schedule, the system may determine scheduling information for the next service event (e.g., a date, a time, a location, a vendor, a vendor employee (or other personnel), etc., for the service event).

In some implementations, the system may first determine a vendor for the next service event. The system may determine a vendor for the next service event based on vendors associated with previous service events for the user of the same service event type. The system may determine a vendor from a preferred vendors list of the user, based on ratings and/or feedback provided by other users (e.g., by all other system users, by other users similar to the user, etc.), and/or by other ways. For example, responsive to the user providing negative feedback about a previous vendor for the same service event type, the system may select a different vendor for the next service event.

Responsive to selecting a vendor for the next service event, the system may determine scheduling information for the next service event. The system may, for example, determine a date and a time that are compatible between the user and the vendor based on the calendar of the user and the calendar of the vendor. Responsive to the user having a preferred employee (or other personnel) of the vendor, the system may also take into account the schedule of the employee (or other personnel) in determining the compatible date and time.

The system may then send information about a potential reservation for the next service event to the user that includes information related to the next service event, the vendor, a date and time for the next service, and/or other information related to the next service event. The system may also send information about the reservation to the selected vendor for the next service event. Responsive to the user accepting the reservation, a confirmation of the reservation may be provided to the user and/or the vendor.

In one implementation, for example, a confirmation may be communicated to the user via email, SMS, MMS, or other communication service. In another implementation, a calendar event for the reservation for the next service event may be included in the user's calendar.

In yet another implementation, a confirmation of the reservation may be communicated to the vendor via email, SMS, MMS, or other communication service. In a further implementation, a reservation for the next service event may be added to the calendar of the vendor. The reservation may comprise payment information from the user that may be used to pay for the services provided in the service event. The system may, for example, automatically pay for the service event using the payment information responsive to receiving an indication from the vendor that the service event is completed.

In some implementations, the automated reservation management system may, for example, comprise a reservation server, a non-transitory electronic storage device that may be communicably coupled to the reservation server, one or more client computing devices, one or more vendor computing devices, a network (via which the reservation server, storage device, client computing devices, and vendor computing devices may communicate), and/or other components (e.g., intermediary (or middle-man) components that manage resources of vendors, or other components).

The reservation server may include a physical processor configured to execute computer readable instructions to implement one or more system components. In some implementations, the server may comprise a non-transitory, tangible computer-readable storage medium with an executable program stored thereon, wherein the program instructs a microprocessor to perform some or all of the functionality of the plurality of system components. The system components may include, for example, a user management component, a vendor management component, a reservation management component, a reservation prediction component, a feedback component, a transaction component, a role-based permissions component, and/or other components.

The user management component may be configured to manage user activities via the system, including, for example, registration of a user, management of calendars of a user, management of service events for a user, and/or other user activities performed via the system. The vendor management component may be configured to manage vendor activities via the system, including, for example, registration of a vendor, management of calendars of a vendor, management of service events for a vendor, and/or other vendor activities performed via the system.

The reservation management component may be configured to receive information for a reservation for a service event, send a request for a potential reservation to a user, upon receiving acceptance of the request, add calendar events for the reservation to the calendars of the user and associated vendor, upon receiving indication from a vendor that service for the service event has been completed, execute payment for the service event based on payment information included in the reservation, and/or perform other functionality related to managing reservations.

The reservation prediction component may be configured to receive an indication of a request for a next service event or predict the need for a next service event, communicate with one or more vendors to determine available times and dates for the next service event, compile information for a reservation for the next service event, manage a list of service events (e.g., priority list or other list) for a user, and/or perform other functionality related to predicting a next service event. The feedback component may be configured to manage feedback from users, vendors, and/or other entities in the system. The transaction component may be configured to execute payment for a service event, and/or perform other functionality related to performing transactions via the system. The role-based permissions component may be configured to tailor access to the system, to a user, to a vendor, to reservations managed by the system, and/or other access to the system based on one or more roles associated with a user of the system.

These and other aspects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 illustrates a block diagram of an exemplary system for automated reservation management, according to an aspect of the invention.

FIG. 2 illustrates a block diagram of an exemplary user management component, according to an aspect of the invention.

FIG. 3 illustrates a block diagram of an exemplary vendor management component, according to an aspect of the invention.

FIG. 4 illustrates an exemplary flowchart for automated reservation management, according to an aspect of the invention.

FIG. 5 illustrates an exemplary screenshot of a home screen, according to an aspect of the invention.

FIG. 6 illustrates an exemplary screenshot of a template for scheduling a service event, according to an aspect of the invention.

FIG. 7 illustrates an exemplary screenshot of a list of service events, according to an aspect of the invention.

FIG. 8 illustrates an exemplary flowchart of predicting the need for a service event, according to an aspect of the invention.

FIG. 9 illustrates an exemplary flowchart of determining scheduling information for a next service event, according to an aspect of the invention.

FIG. 10 illustrates an exemplary screenshot of a potential reservation notification, according to an aspect of the invention.

FIG. 11 illustrates an exemplary flowchart of generating a reservation for the next service event, according to an aspect of the invention.

FIG. 12 illustrates an exemplary flowchart of maintaining a list of service events, according to an aspect of the invention.

FIG. 13 illustrates an exemplary flowchart of generating group reservations, according to an aspect of the invention.

FIG. 14 illustrates an exemplary flowchart of receiving feedback from a user related to a service event, according to an aspect of the invention.

### DETAILED DESCRIPTION

In some implementations, the automated reservation management system 10 may, for example, comprise a reservation server 100, a non-transitory electronic storage device 105 that may be communicably coupled to the reservation server 100, one or more client computing devices 30a, 30b, . . . , 30n, one or more vendor computing devices 40a, 40b, . . . , 40n, a network 20 (via which the reservation server 100, storage device 105, client computing devices 30a, 30b, . . . , 30n, and vendor computing devices 40a, 40b, . . . , 40n may communicate), and/or other components (e.g., intermediary (or middle-man) components that manage resources of vendors, or other components).

By way of example, an administrator of the automated reservation system 10, a user, a vendor, and/or other user may access the automated reservation system 10 via, for example, one or more interfaces (e.g., web pages or other interfaces) communicated from the reservation server 100 to a client device 30n and/or a vendor device 40n, an application such as a mobile application executing on a client device 30n and/or a vendor device 40n that generates the interface based on information communicated from the fund management server 100, an agent running on the reservation server 100, and/or via other interfaces.

The server 100 may include a physical processor 102 configured to execute computer readable instructions to implement one or more system components. In some implementations, the server 100 may comprise a non-transitory, tangible computer-readable storage medium with an executable program stored thereon, wherein the program instructs a microprocessor to perform some or all of the functionality of the plurality of system components. The system components may include, for example, a user management component 110, a vendor management component 120, a reservation management component 130, a reservation prediction component 140, a transaction component 150, a feedback component 160, a role-based permissions component 170, and/or other components 199.

The user management component 110 may be configured to manage user activities via the system, including, for example, registration of a user, management of calendars of a user, management of service events for a user, and/or other user activities performed via the system.

The vendor management component 120 may be configured to manage vendor activities via the system, including, for example, registration of a vendor, management of calendars of a vendor, management of service events for a vendor, and/or other vendor activities performed via the system.

The reservation management component 130 may be configured to receive information related to a reservation of a user with a vendor for a service event, and/or send a request for acceptance of the reservation to the user. The reservation management component 130 may be configured to provide information about the reservation to the user and/or the vendor, for instance, upon the user accepting the reservation (e.g., emailing a confirmation of the reservation to the user and the vendor, adding calendar events for the reservation to the calendars of the user and vendor, etc.). The reservation management component 130 may be configured to execute payment for the service event based on payment information associated with the reservation, for instance, upon receipt of an indication from the vendor that a service associated with the service event has been completed. Other functionality of the reservation management component 130 (such as other functionality related to managing reservations) exists.

The reservation prediction component 140 may be configured to receive an indication of a request for a next service event or predict the need for a next service event (without an explicit request by user for that next service event). The reservation prediction component 140 may be configured to communicate with one or more vendors to determine available dates, times, locations, employees (or other personnel), etc., for the next service event, and/or determine scheduling information compatible with a user for which a next server event is determined or predicted.

The scheduling information may, for example, be determined for a next service event based on calendars associated with user and/or a vendor, temporal information associated with a previous service event (e.g., of the same event type as the service event) that was provided to the user, a predetermined time interval between service events (e.g., of the same event type as the service event), or other information. The scheduling information may comprise a compatible date, time, location, etc., for a next service event, a vendor that is available to provide the service event, an employee (or other personnel) of the vendor that may provide the service event, or other information. As an example, the scheduling information may be determined without the user having to explicitly specify the date, time, location, etc., for the next service event.

The reservation prediction component 140 may be configured to compile information for a reservation for the next service event, manage a list of service events for a user, and/or perform other functionality related to predicting a next service event. The transaction component 150 may be configured to execute payment for a service event, and/or perform other functionality related to performing transactions via the system.

The feedback component 160 may be configured to manage feedback from users, vendors, and/or other entities in the system. The role-based permissions component 170 may be configured to tailor access to the system, to a user, to a vendor, to reservations managed by the system, and/or other access to the system based on one or more roles associated with a user of the system.

In some implementations, the automated reservation management system 10 may manage reservations and transactions in a manner the same or similar as that described in related co-pending U.S. Non-Provisional patent application Ser. No. XX/XXX,XXX, entitled “System and Method for Providing One-Click Booking for a Service Event that Includes Service Transaction Information,” filed on Mar. 12, 2014, which is hereby incorporated by reference in its entirety.

As used herein, a “vendor” may comprise an entity that provides a set of services. An individual service event may comprise a discrete set of services provided from the vendor to a user. Types of service events may, for example, comprise a haircut, a restaurant reservation, a class that includes multiple lessons, and/or other events in which a vendor provides a discrete set of services to a user. The service events that may be reserved via the system 10 are not limited to the examples described herein.

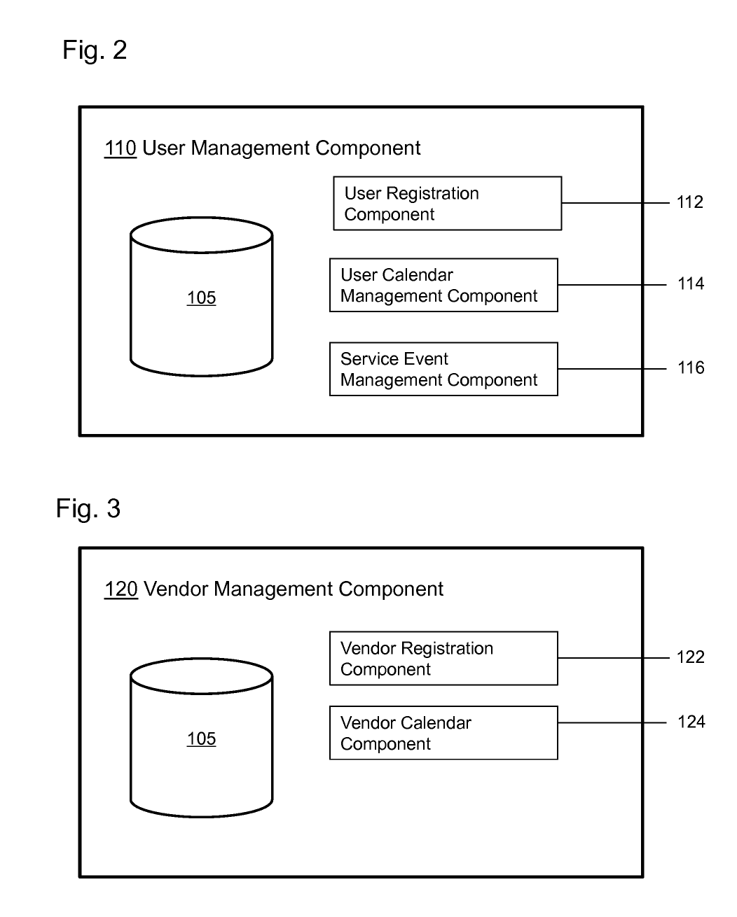

FIG. 2 illustrates a block diagram of an exemplary user management component 110, according to various implementations of the invention. The user management component 110 may be configured to manage user activities via the system, including, for example, registration of a user, management of calendars of a user, management of service events for a user, and/or other user activities performed via the system. In some implementations, the user management component 110 may, for example, comprise a user registration component 112, a user calendar management component 114, a service event management component 116, and/or other system components.

The user registration component 112 may be configured to register users with the system 10, obtain information related to a user, generate a calendar for a user, and/or otherwise facilitate registration of a user with the system 10. For example, the user registration component 112 may be configured to prompt the user for personal information related to the user, payment information which may be associated with the user, information related to the user's interests, and/or other information related to the user. The user registration component 112 may register the user with the system 10 and may obtain and/or generate a user id for the user. In some implementations, the user registration component 112 may create a user profile for the registered user.

The user registration component 112 may also obtain default payment information for the user. The payment information may comprise bank information, credit card information, PayPal information, and/or other acceptable payment information. In some implementations, the user registration component 112 may obtain multiple types of payment information from the user, along with associations between specific payment information and a service event type.

The user registration component 112 may also generate a calendar for the user responsive to registering the user, which may be managed by the user calendar management component 114.

The user calendar management component 114 may add events, revise event, delete events, and/or otherwise manage calendar events for a user calendar. The user calendar management component 114 may send one or more reminders to a user in predetermined time intervals before an event is scheduled to start. The user calendar management component 114 also may perform other functionality typically performed by conventional calendaring systems.

The user calendar management component 114 may add an event to the calendar responsive to receiving event information from a user for the event. In some implementations, the user calendar management component 114 may receive a name of the event, a type of event, location information for the event, a date and time for the event, information related to whether the event is a recurring event, information related to one or more other users that may be associated with the event, and/or other information about the event. The types of events may, for example, comprise service events, user events, and/or other types of events. In some implementations, the types of events may include group events as well.

Responsive to the user indicating that an event is a service event, the user calendar management component 114 may request information related to the type of service event, information related to a vendor for the event, information related to one or more services being provided, an employee (or other personnel) of the vendor that may provide the service associated with the service event, and/or other information related to a service event. The system 10 may store a predetermined set of service event types.

The user calendar management component 114 may also allow a user to create a new type of service event when creating a new service event. The system 10 may store the new service event type responsive to the user creating the new service event type. The user calendar management component 114 may request information related to an identification of the new service event type, a time interval after which another event of a same service event type is typically performed, one or more preferred vendors for the service event type, other user preferences related to the service event type, and/or other information related to the new service event type.

In some implementations, even if a user does not indicate that an event is a service event, the user calendar management component 114 may determine that the new event is a service event responsive to information related to a vendor, service, employee (or other personnel), location associated with a vendor, and/or other information related to a service event and/or vendor being provided by the user.

Responsive to a user indicating that a new event is a service event, the service event management component 116 may manage the service event. The service event management component 116 may maintain a list of service events for a user. In some implementations, the reservation prediction component 140 may manage the service events list for a user.

The service events list may comprise a non-duplicative list of service events performed and/or scheduled for a user. For an individual service event, the service events list may store information related to the service event may be stored. For example, for an individual service event, the service events list may store an identification of the service event, service event type, last scheduled date (either in the past or future), time interval associated with the service event, an indication of whether the time interval was determined by the user, whether the service event should be automatically re-booked, a set of preferred vendors for the service event, a set of removed vendors that should not be used for the service event, and/or other information related to the service event.

In some implementations, the service event management component 116 may update a time interval for a service event in the service events list. For example, the service event management component 116 may update the time interval responsive to receiving input from a user related to the time interval. In another example, the service event management component 116 may update the time interval based on an average number of days between the user scheduling service events for the service event type associated with the time interval.

Responsive to a service event being added to the calendar of a user, the service event management component 116 may determine whether a corresponding service event exists in the service events list. Responsive to the corresponding service event existing, the service event management component 116 may update the last scheduled date/time for the service event to the date/time of the newly added service event. Responsive to the service event not existing, the service event management component 116 may create a new entry for the service event in the service events list.

The service event management component 116 may also maintain lists of preferred vendors by service type, removed vendors by service type, feedback provided by the user regarding vendors, employees (or other personnel), services, etc., feedback provided by other users regarding vendors, employees, services, etc. (e.g., by all other system users, by other users similar to the user, etc.), feedback provided by vendors, employees, and/or other entities related to the user, and/or other information related to the service events for the user.

The service event management component 116 may also allow a user to modify time intervals associated with a specific service event, with a service event type, with a specific vendor, with a specific employee (or other personnel) of a vendor, and/or otherwise modify a time interval. The service event management component 116 may also a user to modify default payment information, payment information associated with a service event type, and/or other payment information associated with the user.

FIG. 3 illustrates a block diagram of an exemplary vendor management component 120, according to various implementations of the invention. The vendor management component 120 may be configured to manage vendor activities via the system, including, for example, registration of a vendor, management of calendars of a vendor, management of service events for a vendor, and/or other vendor activities performed via the system. In some implementations, the vendor management component 120 may, for example, comprise a vendor registration component 122, a vendor calendar management component 124, and/or other system components.

The vendor registration component 122 may register vendors with the system. For example, the vendor registration may register a vendor by obtaining vendor identification information, information about one or more service event types provided by the vendor, information about one or more employees (or other personnel) of the vendor, location of the vendor, and/or other information related to the vendor. The information about an individual service event type provided by the vendor may comprise information about employees of the vendor that provide the service event type, pricing information associated with the service type, and/or other information related to the service event type.

The vendor calendar management component 124 may manage an overall vendor calendar as well as calendars for individual employees (or other personnel) of the vendor. In some implementations, the vendor calendar management component 124 may manage a master vendor calendar that includes overall vendor information (e.g., reservation information, etc.) as well as individual employee events. The vendor calendar management component 124 may receive reservations for service events, may receive private events from employees, and/or may otherwise receive calendar events for the vendor. The vendor calendar management component 124 may add, revise, delete, and/or otherwise manage events for the vendor.

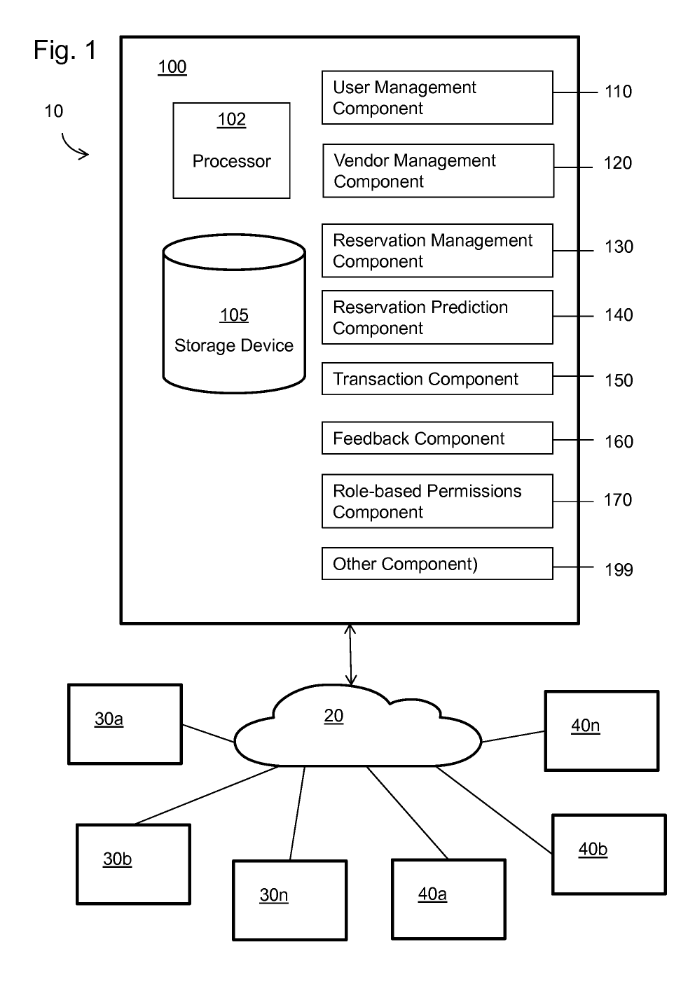

Returning to FIG. 1, the reservation management component 130 may be configured to receive information for a reservation for a service event, send a request for a potential reservation to a user, upon receiving acceptance of the request, add calendar events for the reservation to the calendars of the user and associated vendor, upon receiving indication from a vendor that service for the service event has been completed, execute payment for the service event based on payment information included in the reservation, and/or perform other functionality related to managing reservations.

The reservation management component 130 may receive information for a reservation for a service event from a user, from the reservation prediction component 140, from a vendor providing the service associated with the service event, and/or from other sources related to the service event. For an individual reservation for a vendor, the reservation management component 130 may obtain information related to the service event type associated with the service event in the reservation, information related to the user associated with the service event, information related to an employee (or other personnel) providing the service of the service event, payment information for the service event, a date and time of the service event, and/or other information related to the service event. The reservation management component 130 may obtain this information from the user and the system 10, from the reservation prediction component 140 and/or from other sources.

Upon receiving the information for the reservation, the reservation management component 130 may send information related to the reservation to the user. The information may, for example, comprise some or all of the information obtained for the reservation. Along with information related to the reservation, the reservation management component 130 may send a request for acceptance of the reservation to the user. Upon receiving an acceptance of the reservation, the reservation management component 130 may provide a confirmation of the reservation to the user and/or the vendor associated with the reservation. For example, the reservation management component may send an email that confirms the reservation to the user and the vendor, add information about the reservation to the calendars of the user and the vendor, or communicate the confirmation of the reservation via other approaches.

The reservation management component 130 may send the information related to the reservation, the request for acceptance, confirmation of the reservation, or other information to the user via the user's email address, as a notification on the user's mobile phone, as a pop up on the user's mobile phone, via an app on the user's mobile phone, as a push alert on a user's mobile phone, as a text message to the user's mobile phone, as a SMS message to the user's mobile phone, and/or by other methods of communication to the user.

In some implementations, upon receiving a rejection by the user of the reservation, the reservation management component 130 may query the user as to why the reservation was rejected. In some implementations, upon receiving a rejection by the user of the reservation, reservation management component 130 may also query the user as to whether the user would like a reservation with another vendor for the service event. Upon receiving an indication that the user would like another vendor, the reservation management component 130 may determine another vendor for the service event, query the reservation prediction component 140 to receive information related to a reservation with another vendor, and/or otherwise determine another vendor for the service event. In some examples, the reservation management component 130 may also add the vendor associated with the reservation to the removed vendors list for the service event type.

Upon receiving an indication from a vendor that a service for a service event has been completed, the reservation management component 130 may send an indication to transaction component 150 to process payment for the service event based on payment information associated with the reservation for the service event.

The reservation prediction component 140 may be configured to receive an indication of a request for a next service event or predict the need for a next service event (without a user submitting a request for that specific service event), communicate with one or more vendors to determine available dates, times, locations, employees (or other personnel), etc., for the next service event, determine scheduling information compatible with a user for which a next server event is determined or predicted, compile information for a reservation for the next service event, manage a list of service events for a user, and/or perform other functionality related to predicting a next service event.

In some implementations, the reservation prediction component 140 may receive an indication of a service event type based on user input with the system 10.

In some implementations, the reservation prediction component 140 may determine a need for a service event of a service event type. For example, the reservation prediction component 140 may determine the need for a next service event for a user based on a list of service events for the user. The reservation prediction component 140 may determine a next set of service events for which reservations may be needed in a next predetermined time period. For example, the reservation prediction component 140 may calculate the addition of the time interval to the last scheduled date for each service event in the service events list, and select those service events for which the calculated date falls within the predetermined time period after the current date on which the calculation was performed. The reservation prediction component 140 may choose a first service event of the next set of service events for which the calculated date is earliest as the service event for which a reservation may be generated. Other ways of predicting the service event may be used as well.

Based on the determining that a reservation for a service event of a service event type needs to be generated (e.g., from receiving the indication of the service event type, predicting the need for the service event of the service event type, and/or in other ways), the reservation prediction component 140 may determine a vendor for the service event type. The reservation prediction component 140 may determine the vendor for the service event based on one or more vendors used for previous service events of the service event type. For example, the reservation prediction component 140 may select the vendor for the service event type based on whether a same vendor has been used for a predetermined number of immediately previous service events of the same service event type, a vendor from a preferred set of vendors associated with the service event type, and/or otherwise select a vendor based on the user's association with a vendor.

In various implementations, responsive to the user not having an association with a vendor, or the user providing negative feedback regarding a vendor for a service event of the same service event type, the reservation prediction component 140 may select a vendor based on feedback received for vendors in a location within a predetermined proximity threshold (e.g., a certain distance, a certain amount of travel time, etc.) from the user (e.g., the user's current location, the user's residence, etc.). In some implementations, the reservation prediction component 140 may select the vendor based on feedback received for vendors regardless of whether the user has an association with any vendors registered with the system.

In some implementations, the reservation prediction component 140 may select the vendor based on a location associated with a previous vendor that provided a previous service event for the user. For example, a set of vendors that each provide service events (of the same service event type as the previous service event) at a location within a predetermined proximity threshold (e.g., a certain distance, a certain amount of travel time, etc.) from the location associated with the previous vendor may be determined. The vendor may, for instance, be selected from the set of vendors based on feedback from a set of users related to the set of vendors (e.g., users to which the set of vendors previously provided services or other related users).

It should be appreciated that the set of users whose feedback (e.g., regarding a set of vendors) is used to select a vendor for a service event for a user may, for example, comprise all other system users, other users that are similar to the user, other users that are within the social network of the user, etc. As an example, other users may be determined as similar to the user based on the other users being associated with locations in proximity to the user, the other users having similar interests with the user, the other users having been provided services similar to services that the user has been provided, or other similarity criteria.

Responsive to the reservation prediction component 140 determining a vendor for the service event of the service event type, the reservation prediction component 140 may determine a date and time for the reservation. The reservation prediction component 140 may determine scheduling information based on the availability of the vendor and the availability of the user. For example, the reservation prediction component 140 may determine a date and time (or other scheduling information) for the reservation based on the calendar of the determined vendor and the user calendar. In some implementations, the reservation prediction component 140 may determine a date and time (or other scheduling information) for the reservation based also on an employee (or other personnel) of the vendor to be used for the service event.

Responsive to the reservation prediction component 140 determining the information for the reservation, the reservation prediction component 140 may send the reservation information to the reservation management component 130.

In some implementations, the reservation prediction component 140 may manage the service events list in a manner the same as or similar to the user management component 110. In some implementations, the reservation prediction component 140 may manage the service events list instead of the user management component 110.

The transaction component 150 may be configured to execute payment for a service event, and/or perform other functionality related to performing transactions via the system. Responsive to receiving an indication from the reservation management component 130 to execute payment for a service event, the transaction component 150 may obtain payment information for the service event from the reservation for the service event.

In some implementations, the transaction component 150 may query the user whether the user wants a breakdown of prices, whether the user wants to include a tip for the service event, and/or other for other preferences of the user responsive to receiving an indication to execute payment for the service event. In some implementations, the system 10 may store user preferences regarding payment (e.g., regarding whether to provide a breakdown, to include a tip, and/or other user preferences).

Based on user preferences with the payment information, the transaction component 150 may determine a tip for the service event and add the tip amount to the amount for the service event. In some implementations, the transaction component 150 may also provide the user with a breakdown of price(s) for service(s) provided in the service event, tip(s) provided, and/or other costs of the service event before executing payment for the service event. For example, the transaction component 150 may provide the breakdown and only execute payment responsive to receiving approval from the user to pay for the service event.

In some implementations, the transaction component 150 may enable the user to add or modify a tip for the service event before or after an indication that the service event is completed. For example, the user may wish to perform a one-time modification of a tip ordinarily set to a certain amount (e.g., based on preferences indicating a certain percentage) before the service event is completed so that the user does not need to remember to modify the tip thereafter. As another example, upon being very satisfied with the services of a vendor, the user may modify a tip ordinarily set to a default (or other) amount after the service event is completed.

In one implementation, the time in which a user may add or modify a tip for a service event before the service event is completed may be restricted (e.g., fraud or other reasons). As an example, addition or modification of a tip may be restricted to after a scheduled occurrence of the service event, a predetermined time period after the scheduled occurrence, a predetermined time period after a reservation with a vendor for the service event is confirmed, etc. As another example, addition or modification of a tip before the service event is completed may be restricted to within a predetermined time period of the scheduled occurrence of the service event. Whether addition or modification of a tip may thus be based on a determination of whether a current time satisfies one or more of the above restrictions.

In another implementation, the time in which a user may add or modify a tip for a service event after the service event is completed may be restricted. For example, addition or modification of a tip for the service event may be restricted to a predetermined time period after the service is completed. In one use case, a user may be able to add or modify a tip within 24 hours of an indication (e.g., by a vendor that provided the service event) that the service event is completed. Thereafter, payment comprising the tip (if any) and the cost of the service event may be executed. In another use case, a user may be able to add or modify a tip any time after the service event is completed until payment comprising the tip (if any) and the cost of the service event is processed.

Responsive to no payment information being included in the reservation, the transaction component 150 may use default payment information associated with the user to execute payment. In some implementations, the transaction component 150 may query the user for payment information responsive to no payment information being included in the reservation.

The transaction component 150 may execute payment for the service event based on the payment information included in the reservation. The transaction component 150 may execute payment in a conventional manner, based on the type of payment information included.

The feedback component 160 may be configured to manage feedback from users, vendors, and/or other entities in the system. The feedback component 160 may receive feedback from a user regarding a service event. For example, the feedback component 160 may receive feedback related to the vendor, an employee (or other personnel) of the vendor, the venue, the location, parking by the vendor, and/or other information related to the service event. The feedback may be one or more of written feedback, may be a qualitative and/or quantitative rating, video, one or more pictures, and/or other indications of feedback from the user.

The feedback component 160 may facilitate the sharing of feedback provided by the user responsive to the user's request to make the feedback public or share the feedback with specific other users. The feedback component 160 may also facilitate commenting on the feedback, responses to the feedback from vendors, and/or other customizations related to the feedback based on the user's received preferences.

In some implementations, the feedback component 160 also may receive feedback regarding a service event from a vendor, an employee (or other personnel) providing a service for the service event, and/or other vendor entity. For example, the feedback component 160 may receive feedback related to the user associated with the service event. The feedback may be one or more of written feedback, may be a qualitative and/or quantitative rating, video, one or more pictures, and/or other indications of feedback from the vendor.

The feedback component 160 may facilitate the sharing of feedback provided by the vendor with the user for whom the feedback was provided. In some implementations, the feedback component 160 may also facilitate sharing of the feedback with one or more employees (or other personnel), a system administrator, and/or other entities based on vendor preferences or customization.

The role-based permissions component 170 may be configured to tailor access to the system, to a user, to a vendor, to reservations managed by the system, and/or other access to the system based on one or more roles associated with a user of the system. The role-based permission component 170 may be configured to tailor access to the system based on roles of various users including, for example, a role in the system, and/or other roles. System-level roles may grant access to various system features such as for example, access to one or more components, access to content stored at a storage component, and/or other access to system features. System-level roles may be configured, for example, to manage storage of information in the non-transitory electronic storage device 105, access to information related to users, access to information related to vendors, access to reservations, access to feedback, and/or other system-level features. Different system-level roles may be granted that provide access to different system features. User-level roles may grant access to various features related to users, such as, for example, access to information related to vendors and services provided by vendors, access to information of employees (or other personnel) of vendors, access to ratings and/or feedback related to vendors, and/or other access. Vendor-level roles may grant access to various features related to vendors, such as, for example, access to information related to users and services obtained by users, access to information of employees of vendors, access to ratings and/or feedback for the vendor, and/or other access. The role-based permissions component 170 may maintain a plurality of roles, including, for example, administrator of the management system, user, vendor, and/or other roles.

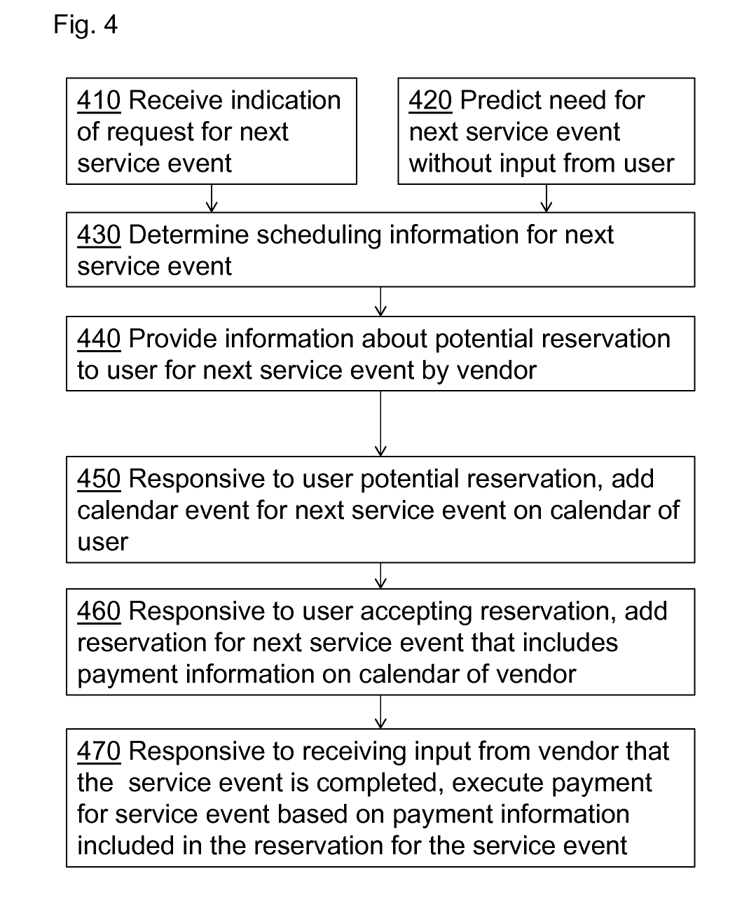

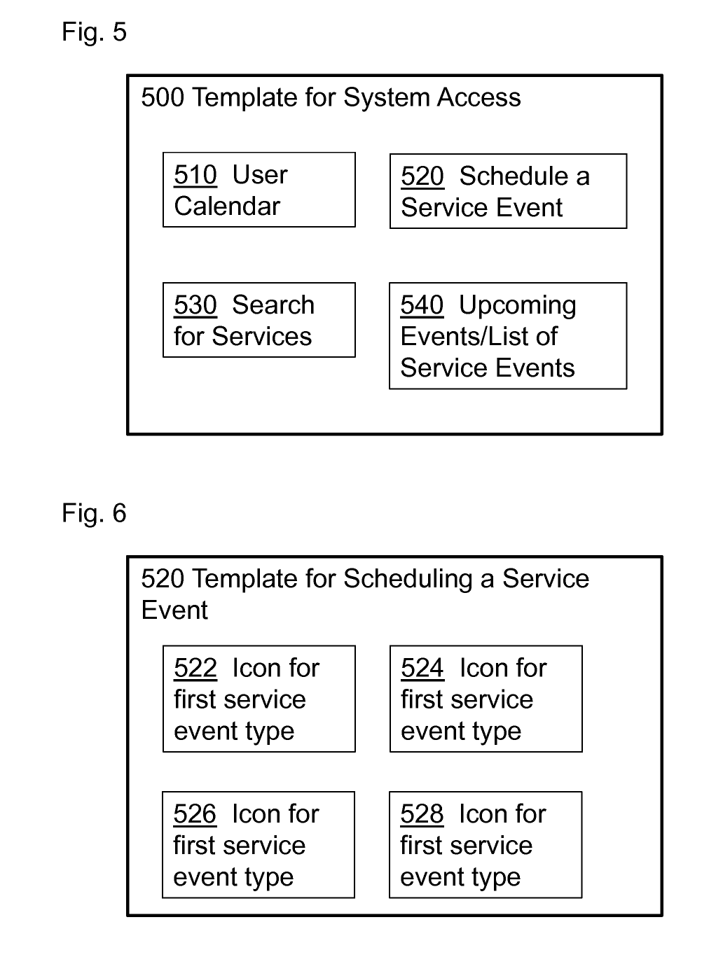

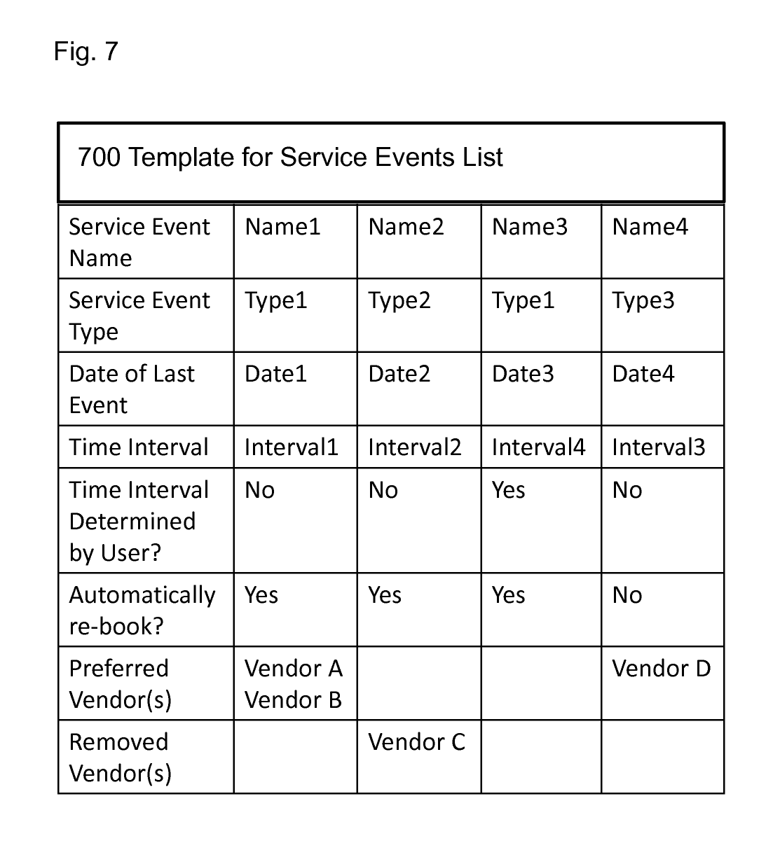

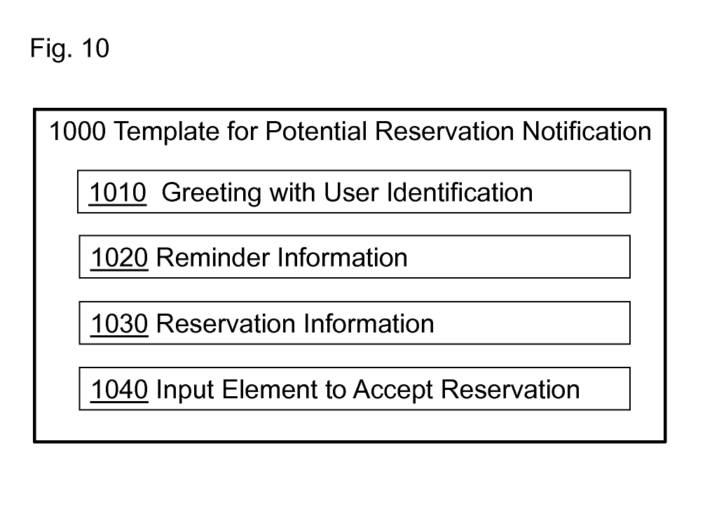

FIG. 4 illustrates an exemplary process for automated reservation management, according to various implementations of the invention. FIG. 5 depicts an exemplary screenshot of an interface 500 that includes a template for system access, according to an aspect of the invention. FIG. 6 depicts an exemplary screenshot of an interface 600 that includes a template for scheduling a service event of a particular service event type, according to an aspect of the invention. FIG. 7 illustrates an exemplary screenshot of a list of service events, according to an aspect of the invention. FIG. 10 illustrates an exemplary screenshot of a potential reservation notification, according to an aspect of the invention. Processing will be described with respect to FIG. 4 in reference to the screen shots depicted in FIGS. 5-7 and 10.

The described operations of FIG. 4 and other figures may be accomplished using some or all of the system components described in detail above and, in some implementations, various operations may be performed in different sequences. In other implementations, additional operations may be performed along with some or all of the operations shown in FIG. 3 and the other figures. In yet other implementations, one or more operations may be performed simultaneously. In yet other implementations, one or more combinations of various operations may be performed. Some implementations may not perform all of the operations described with relation to FIG. 4 and other figures. Accordingly, the operations described are exemplary in nature and, as such, should not be viewed as limiting.

In some embodiments, the operations described in FIG. 4 and the other figures may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations described in FIG. 4 and the other figures in response to instructions stored electronically on an electronic storage medium. The one or more processing devices may include one or more devices configured through hardware, firmware, and/or software to be specifically designed for execution of one or more of the operations described in FIG. 4 and the other figures.

The screenshots illustrated in FIG. 5 and other drawing figures are exemplary in nature. Various components may be added, deleted, moved, or otherwise changed so that the configuration, appearance, and/or content of the screenshots may be different than that illustrated in the figures. Accordingly, the graphical user interface objects as illustrated (and described in greater detail below) are exemplary by nature and, as such, should not be viewed as limiting.

Interface 500 and other interfaces described herein may be implemented as a web page communicated from computing device 100 to a client device, an application such as a mobile application executing on the client device that generates the interface based on information communicated from computing device 100, and/or other interface. Whichever type of interface is used, computing device 100 may communicate the data and/or formatting instructions related to the interface to the client device, causing the client device to generate the various interfaces of FIG. 5 and other interfaces. Furthermore, computing device 100 may receive data from the client device via the various interfaces.

In an operation 410, the reservation management system 10 may receive an indication of a request for a next service event. The reservation prediction component 140 may receive an indication of a request for a next service event in a manner the same or similar as that described above. In some implementations, the system 10 may have presented a template for system access to the user. FIG. 5 depicts an exemplary screenshot of an interface 500 that includes a template for system access, according to an aspect of the invention. The template for system access may present (to a user) functionality associated with user registration component 112, reservation management component 130, reservation prediction component 140, and/or other components of server 100. In some implementations, and as shown in FIG. 5, the template for system access may comprise a user selectable link for the user calendar 510, via which the user may view the user calendar, a user selectable link for scheduling a service event 520, a user selectable link for searching for available service events 530, a user selectable list for a list of upcoming events 540, and/or other user selectable links. Other user interactive elements may be used as well.

In some implementations, the user selectable link for the user calendar 510 may display the user calendar.

In some implementations, the user selectable link for scheduling a service event 520 may present a template for scheduling a service event of a particular service event type. FIG. 6 depicts an exemplary screenshot of an interface 600 that includes a template for scheduling a service event of a particular service event type, according to an aspect of the invention. As shown in FIG. 6, the interface 600 may comprise indicators, icons, and/or other identifiers for a plurality of service event types (e.g., service event types 522, 524, 526, 528, and/or other service event types). Responsive to a user selecting a service event type, the reservation prediction component 140 may receive the indication of service event type and determine a reservation related to a service event for the service event type.

In some implementations, the user selectable link for searching for available service events 530 may allow a user to search for available service event types, vendors, ratings and/or other feedback related to vendors registered with the system 10, and/or other information related to service events.

In some implementations, the user selectable link for a list of upcoming events 540 may present the user with a template for the service events list of the user and may allow the user to add, revise, delete, and/or otherwise modify entries in the service events list. FIG. 7 depicts an exemplary screenshot of an interface 600 that includes a template for displaying a list of service events, according to an aspect of the invention. As shown in FIG. 7, the interface 700 may comprise the entries included in the service events list. The interface 700 may also include user interactive elements to add, remove, edit, and/or otherwise manage an entry in the service events list.

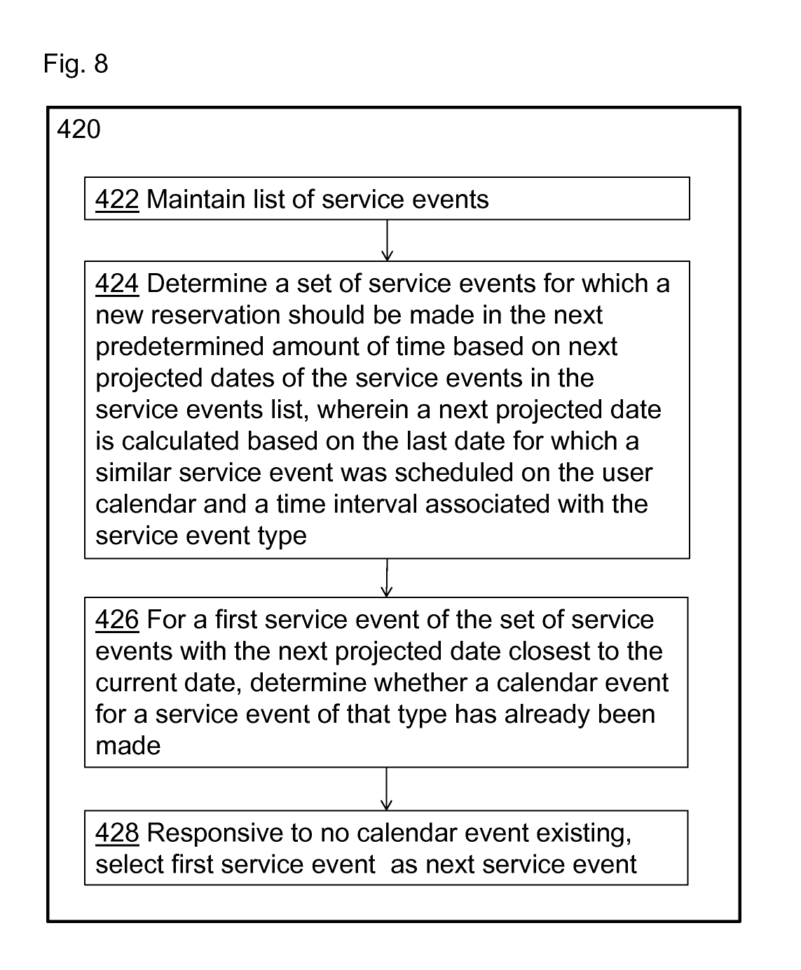

Returning to FIG. 4, in an operation 420, the reservation management system 10 may predict a need for a next service event. The reservation prediction component 140 may predict a need for a next service event in a manner the same or similar as that described above. FIG. 8 illustrates an exemplary process of predicting a need for a next service event via the system 10, according to various implementations of the invention.

In an operation 422, the reservation management system 10 may maintain a list of service events for the user. The reservation prediction component 140 may maintain the service events list in a manner the same or similar as that described above.

In an operation 424, the reservation management system 10 may determine a set of service events for which new reservations may be made in a next predetermined amount of time, based on next projected dates for service events in the service events list. The reservation prediction component 140 may determine the set of service events in a manner the same or similar as that described above.

In an operation 426, for a first service event of the determined set of service events, the reservation management system 10 may determine whether a calendar event for the first service event has already been made. The reservation prediction component 140 may determine whether a calendar event exists in a manner the same or similar as that described above.

In an operation 428, responsive to a corresponding calendar event not existing, the reservation management system 10 may select the first service event as a next service event for which a reservation may be generated. The reservation prediction component 140 may select the first service event as a next service event in a manner the same or similar as that described above.

Returning to FIG. 4, in an operation 430, the reservation management system 10 may determine scheduling information for the next service event. The reservation prediction component 140 may determine scheduling information for the next service event in a manner the same or similar as that described above. The scheduling information may comprise a compatible date, time, location, etc., for the next service event, a vendor that is available to provide the service event, an employee (or other personnel) of the vendor that may provide the service event, or other information.

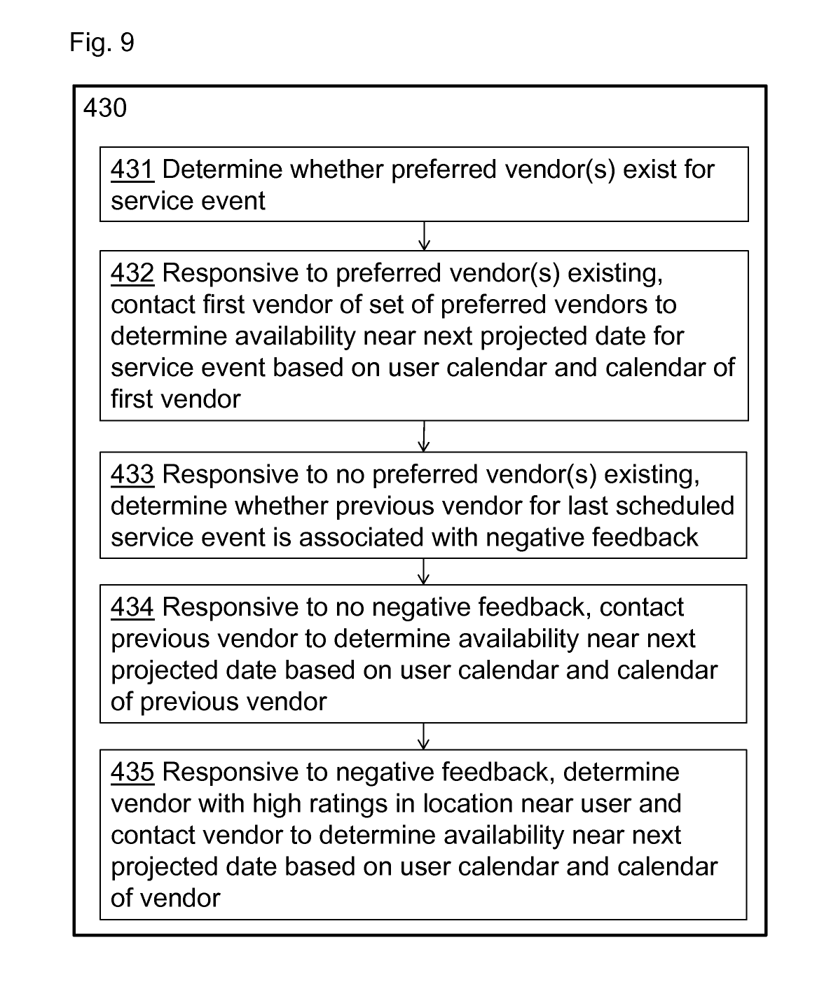

FIG. 9 illustrates an exemplary flowchart of determining scheduling information for a next service event, according to an aspect of the invention.

In an operation 431, the reservation management system 10 may determine whether preferred vendor(s) exist for the service event. The reservation management component 130 may determine whether preferred vendor(s) exist in a manner the same or similar as that described above.

In an operation 432, the reservation management system 10 may contact a first vendor of a set of preferred vendors responsive to preferred vendors existing for the service event. The reservation management component 130 may contact the first vendor in a manner the same or similar as that described above.

In an operation 433, the reservation management system 10 may determine whether a previous vendor for last scheduled service event is associated with negative feedback, responsive to no preferred vendors existing for the service event. The reservation management component 130 may determine whether a previous vendor is associated with negative feedback in a manner the same or similar as that described above.

In an operation 434, the reservation management system 10 may contact the previous vendor to determine availability near the next projected date for the service event based on the user calendar and the calendar of the previous vendor, responsive to the previous vendor not being associated with negative feedback. The reservation management component 130 may contact the previous vendor in a manner the same or similar as that described above.

In an operation 435, the reservation management system 10 may determine one or more vendors with high rations in a location near the user and may contact a first vendor of the determined one or more vendors to determine availability near the next projected date for a service event, responsive to the previous vendor being associated with negative feedback. The reservation management component 130 may determine highly rated vendors and contact such a vendor in a manner the same or similar as that described above.

Returning to FIG. 4, in an operation 440, the reservation management system 10 may provide information about a potential reservation to the user for the next service event, where the reservation includes a service event provided by a first vendor. The reservation management component 130 may provide information about the reservation in a manner the same or similar as that described above.

FIG. 10 illustrates an exemplary screenshot of a potential reservation notification, according to an aspect of the invention. As shown in FIG. 10, the interface 1000 may, for example, comprise a greeting to the user with user identification 1010, reminder information related to the service event 1020, information related to the reservation 1030, an input element via which the user may accept the reservation 1040, and/or other information related to the potential reservation. The reminder information 1020 may, for example, comprise information related to an immediately previous service event for the same service event type as the service event of the potential reservation.

In an operation 450, the reservation management system 10 may add the calendar event for the next service event on the calendar of the user, responsive to the user accepting the potential reservation. The reservation management component 130 may add the calendar event for the next service event on the calendar of the user in a manner the same or similar as that described above.

In an operation 460, the reservation management system 10 may add the reservation for the next service event on the calendar of the vendor, where the reservation includes payment information for the service event. The reservation management component 130 may add the reservation for the next service event on the calendar of the vendor in a manner the same or similar as that described above.

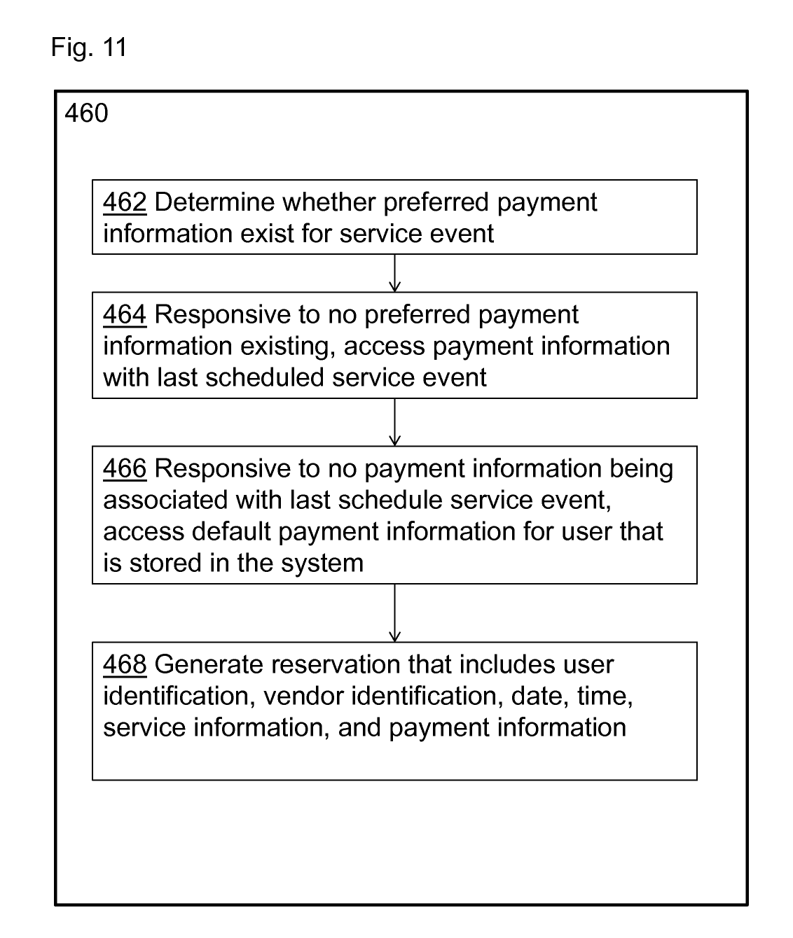

FIG. 11 illustrates an exemplary process of adding the reservation via the system 10, according to various implementations of the invention.

In an operation 462, the reservation management system 10 may determine whether preferred payment information exists for the service event. The reservation management component 130 may determine whether preferred payment information exists in a manner the same or similar as that described above.

In an operation 464, the reservation management system 10 may access payment information associated with the last scheduled event responsive to no preferred payment information existing. The reservation management component 130 may access payment information associated with the last scheduled event in a manner the same or similar as that described above.

In an operation 466, the reservation management system 10 may access default payment information responsive to no payment information being associated with the last scheduled service event. The reservation management component 130 may access default payment information in a manner the same or similar as that described above.

In an operation 468, the reservation management system 10 may generate a reservation that includes one or more of user identification, vendor identification, date, time, service information, payment information, and/or other information related to the service event. The reservation management component 130 may generate the reservation in a manner the same or similar as that described above.

Returning to FIG. 4, in an operation 470, the reservation management system 10 may execute payment for the service event based on payment information included in the reservation for the service event, responsive to receiving input from the vendor that the service event has been completed. The reservation management component 130 may execute payment for the service event in a manner the same or similar as that described above.

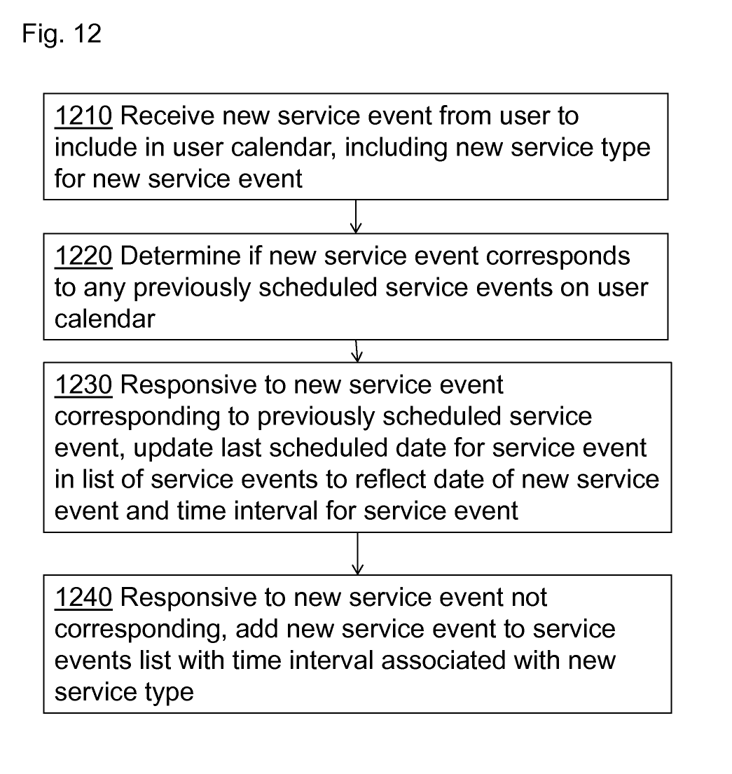

FIG. 12 illustrates an exemplary flowchart of maintaining a list of service events, according to an aspect of the invention.

In an operation 1210, the reservation management system 10 may receive a new service event from a user to include in the user calendar, where the new service event may include a service event type for the new service event. The service event management component 116 may receive the new service event in a manner the same or similar as that described above.

In an operation 1220, the reservation management system 10 may determine whether the new service event corresponds to any previously scheduled service events on the user calendar. The service event management component 116 may determine whether the new service event corresponds to any previously scheduled service events on the user calendar in a manner the same or similar as that described above.

In an operation 1230, the reservation management system 10 may update a last scheduled date associated with a service event responsive to that service event corresponding to the new service event. The service event management component 116 may update the last scheduled date in a manner the same or similar as that described above.

In an operation 1240, the reservation management system 10 may add the new service event to the service events list responsive to the new service event not corresponding to any previously events on the user calendar. The service event management component 116 may add the new service event co in a manner the same or similar as that described above.

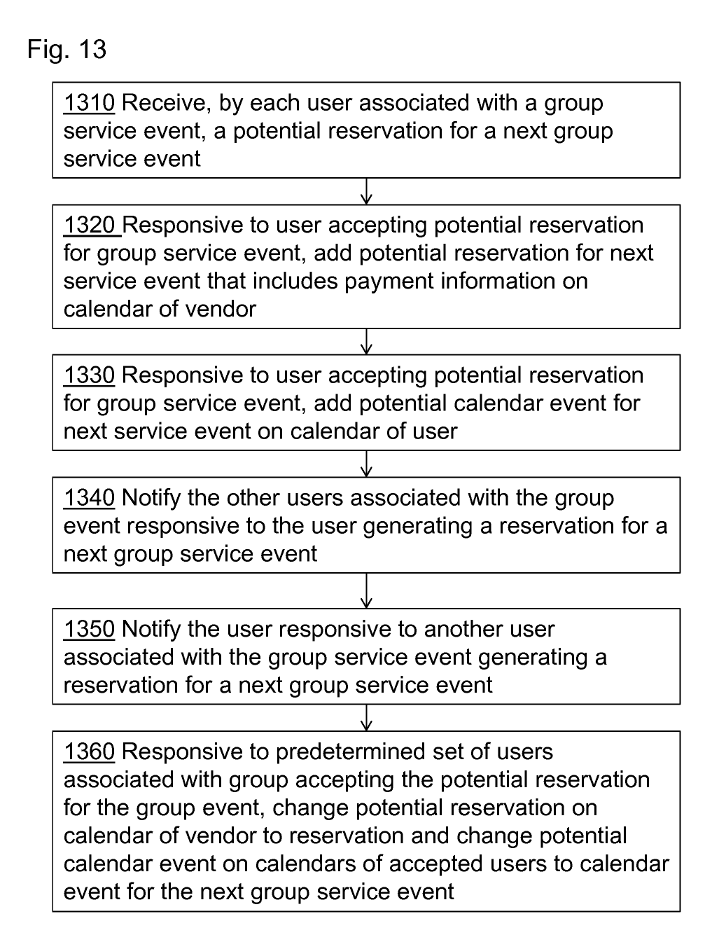

FIG. 13 illustrates an exemplary flowchart of generating group reservations, according to an aspect of the invention.

In an operation 1310, the reservation management system 10 may receive, from each user associated with a group service event, a potential reservation for a next group event. The reservation prediction component 140 may receive the potential reservations in a manner the same or similar as that described above.

In an operation 1320, the reservation management system 10 may add the potential reservation for the next group event to the calendar of a vendor responsive to a user accepting the potential reservation for the group service event. The reservation prediction component 140 may add the potential reservation to the calendar of the vendor in a manner the same or similar as that described above.

In an operation 1330, the reservation management system 10 may add the potential reservation for the next group event to the user calendar responsive to the user accepting the potential reservation. The reservation prediction component 140 may add the potential reservation to the user calendar in a manner the same or similar as that described above.

In an operation 1340, the reservation management system 10 may notify the other users associated with the group event responsive to the user accepting the reservation for the next group service event. The reservation prediction component 140 may notify the other users associated with the group event in a manner the same or similar as that described above.

In an operation 1350, the reservation management system 10 may notify the user responsive to one or the other users associated with the group event accepting the reservation for the next group event. The reservation prediction component 140 may notify the user in a manner the same or similar as that described above.

In an operation 1360, the reservation management system 10 may change the potential reservation on the calendar of the vendor to a group reservation and change the potential calendar event on the calendars of users that accepted the potential reservation to a group service event responsive to a predetermined number of the users associated with the group accepting the potential reservation. The reservation prediction component 140 may change the potential reservation in a manner the same or similar as that described above.

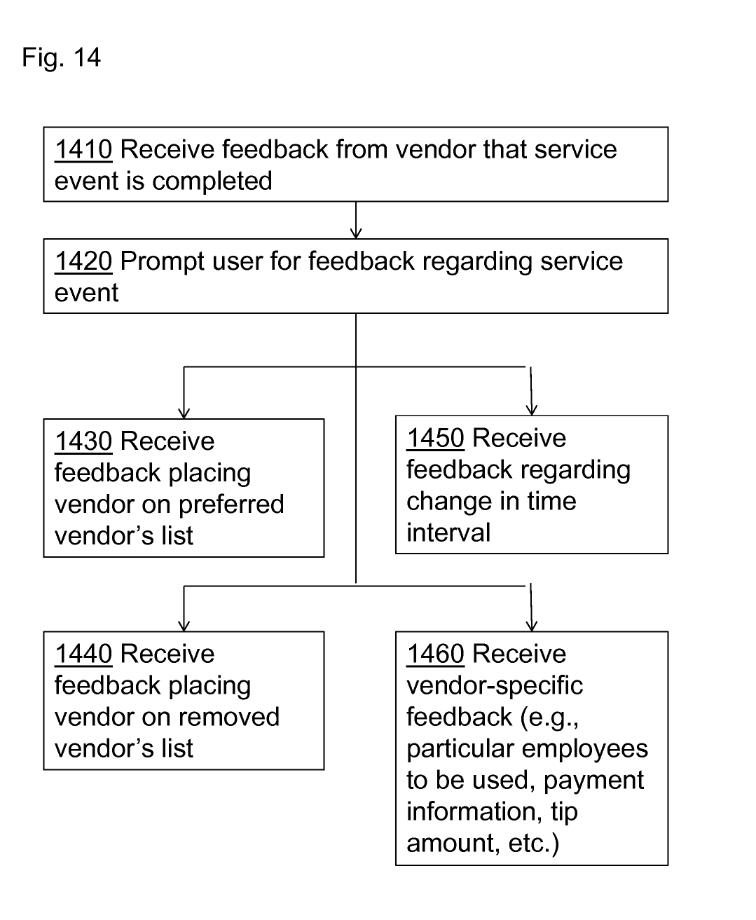

FIG. 14 illustrates an exemplary flowchart of receiving feedback from a user related to a service event, according to an aspect of the invention.

In an operation 1410, the reservation management system 10 may receive feedback from the vendor indicating that the service event is completed. The reservation management component 130, transaction component 150, feedback component 160, and/or other components may receive feedback from the vendor indicating that the service event is completed in a manner the same or similar as that described above.

In an operation 1420, the reservation management system 10 may prompt the user for feedback regarding the service event. The feedback component 160 may prompt the user for feedback regarding the service event in a manner the same or similar as that described above.

In an operation 1430, the reservation management system 10 may receive feedback from the user including the vendor in the set of preferred vendors for the service type of the service event. The feedback component 160 may receive feedback from the vendor including the vendor in the set of preferred vendors in a manner the same or similar as that described above.

In an operation 1440, the reservation management system 10 may receive feedback from the vendor indicating that the service event is completed. The feedback component 160 may receive feedback from the vendor indicating that the service event is completed in a manner the same or similar as that described above.

In an operation 1450, the reservation management system 10 may receive feedback from the user including the vendor in the set of removed vendors for the service type of the service event. The feedback component 160 may receive feedback from the vendor including the vendor in the set of removed vendors in a manner the same or similar as that described above.

In an operation 1460, the reservation management system 10 may receive vendor-specific feedback from the user indicating that the service event is completed. The vendor-specific feedback may, for example, comprise information related to particular employees (or other personnel) to be used for the service event, payment information, tip amount, and/or other vendor-specific feedback. The feedback component 160 may receive feedback from the vendor indicating that the service event is completed in a manner the same or similar as that described above.

The server 100 may be any computing device such as, for example, a server, a desktop computer, laptop computer, personal digital assistant, smart phone, and/or any other computing device. Other configurations and system architectures may be used. For example, although not shown, server 100 may be or include one or more servers connected to one or more clients via a network 20 such as a Wide Area Network, Local Area Network, the Internet, a cloud-based network and/or other network or combination thereof. The server 100 may be capable of communicating with network 20, non-transitory electronic storage device 200, client computing devices 30a, 30b, . . . , 30n, vendor computing devices 40a, 40b, . . . , 40n, and/or other computing devices. The server 100 may include a plurality of hardware, software, and/or firmware components operating together to provide the functionality attributed herein to server 100. For example, server 100 may be implemented by a cloud of computing platforms operating together as server 100.

A client device 30n may facilitate communication with the server 100. For example, a user (e.g., a consumer or other user) may communicate with the server 100 via a client device 30n. In some implementations, the term “user” may be interchangeably used herein with the term “client device.” In some implementations, a user's actions and/or functionality as described herein may be carried out and/or implemented by a client device 30n. A client device 30n may include one or more processors that are configured to execute computer program components. The computer program components may be configured to enable an expert or user associated with the client device 30n to interface with system 10 and/or other components of the system 10, and/or provide other functionality attributed herein to client device 30n. By way of non-limiting example, the client device 300n may include one or more of a desktop computer, a laptop computer, a handheld computer, a tablet computing platform, a Netbook, a Smartphone, a gaming console, and/or other computing platforms. The client device 30n may be capable of communicating with network 20, server 100, non-transitory electronic storage device 105, vendor computing devices 40a, 40b, . . . , 40n and/or other computing devices.

A vendor computing device 40n may facilitate communication with the server 100. For example, a user (e.g., an owner, employee, or other user associated with a vendor) may communicate with the server 100 via a vendor computing device 40n. In some implementations, the term “user” may be interchangeably used herein with the term “vendor device.” In some implementations, a user's actions and/or functionality as described herein may be carried out and/or implemented by a vendor computing device 40n. A vendor computing device 40n may include one or more processors that are configured to execute computer program components. The computer program components may be configured to enable an expert or user associated with the vendor computing device 40n to interface with system 10 and/or other components of the system 10, and/or provide other functionality attributed herein to vendor computing device 40n. By way of non-limiting example, the vendor computing device 40n may include one or more of a desktop computer, a laptop computer, a handheld computer, a tablet computing platform, a Netbook, a Smartphone, a gaming console, and/or other computing platforms. The vendor computing device 40n may be capable of communicating with network 20, server 100, non-transitory electronic storage device 105, client computing devices 30a, 30b, . . . , 30n and/or other computing devices.

The non-transitory electronic storage device 105 may be at least one database that stores system data such as information related to users, vendors, service events, reservations, information related to activity performed via the system 10, and/or any other data. The non-transitory electronic storage device 105 may be associated and communicate with the server 100.

The one or more databases comprising the non-transitory electronic storage device 105 may be, include, or interface to, for example, an Oracle™ relational database sold commercially by Oracle Corporation. Other databases, such as Informix™, DB2 (Database 2) or other data storage, including file-based, object, or query formats, platforms, or resources such as OLAP (On Line Analytical Processing), SQL (Standard Query Language), NoSQL, a SAN (storage area network), Microsoft Access™ or other form of database may also be used, incorporated, or accessed. The database may comprise one or more such databases that reside in one or more physical devices and in one or more physical locations. The database may store a plurality of types of data and/or files and associated data or file descriptions, administrative information, or any other data.

In some implementations, the non-transitory electronic storage device 105 may be part of or hosted by a computing device on the network 20. In some implementations, the non-transitory electronic storage device 105 may be part of or hosted by the server 100. In some implementations, the non-transitory electronic storage device 105 may be physically separate from the server 100 but may be operably communicable therewith.

In some implementations, the non-transitory electronic storage device 105 may comprise electronic storage media that electronically stores information. The non-transitory electronic storage device 105 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The non-transitory electronic storage device 105 may include one or more virtual storage resources (e.g., cloud storage, a virtual private network, and/or other virtual storage resources). The non-transitory electronic storage device 105 may store software algorithms, information determined by processor 102, information received from server 100, information received from client devices 30a, 30b, . . . 30n, information received from vendor devices 40a, 40b, . . . , 40n, and/or other information that enables server 100 to function as described herein.

Processor(s) 102 is configured to provide information processing capabilities in computing device 100. As such, processor 102 may include one or more of a digital processor, an analog processor, a digital circuit designed to process information, an analog circuit designed to process information, a state machine, and/or other mechanisms for electronically processing information. Although processor 102 is shown in FIG. 1 as a single entity, this is for illustrative purposes only. In some implementations, processor 102 may include a plurality of processing units. These processing units may be physically located within the same device, or processor 102 may represent processing functionality of a plurality of devices operating in coordination. The processor 102 may be configured to execute components 110, 120, 130, 140, 150, 160, and/or other components. Processor 102 may be configured to execute components 110, 120, 130, 140, 150, 160, and/or components by software; hardware; firmware; some combination of software, hardware, and/or firmware; and/or other mechanisms for configuring processing capabilities on processor 102.

It should be appreciated that although components 110, 120, 130, 140, 150, 160, and/or other components are illustrated in FIG. 1 as being co-located within a single processing unit, in implementations in which processor 101 includes multiple processing units, one or more of components 110, 120, 130, 140, 150, 160, and/or other components may be located remotely from the other components. The description of the functionality provided by the different components 110, 120, 130, 140, 150, 160, and/or other components described below is for illustrative purposes, and is not intended to be limiting, as any of components 110, 120, 130, 140, 150, 160, and/or other components may provide more or less functionality than is described. For example, one or more of components 110, 120, 130, 140, 150, 160, and/or other components may be eliminated, and some or all of its functionality may be provided by other ones of components 110, 120, 130, 140, 150, 160, and/or other components. As another example, processor 102 may be configured to execute one or more additional components that may perform some or all of the functionality attributed below to one of components 110, 120, 130, 140, 150, 160, and/or other components.

In addition, implementations of the invention may be made in hardware, firmware, software, or any suitable combination thereof. Aspects of the invention may also be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Further, firmware, software, routines, or instructions may be described herein in terms of specific exemplary aspects and implementations of the invention, and performing certain actions. However, it will be apparent that such descriptions are merely for convenience and that such actions in fact result from computing devices, processors, controllers, or other devices executing the firmware, software, routines, or instructions.

Aspects and implementations described herein as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other aspects or implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims. In addition, it should be appreciated that, to the extent possible, one or more features of any implementation described herein may be combined with one or more features of any other implementation described herein.

1. A system for facilitating booking of service events based on amounts of time between previous service events, the system comprising:
one or more physical processors programmed to execute one or more computer program instructions which, when executed, cause the one or more physical processors to:
determine amounts of time between previous service events of a first service event type that were scheduled for a user, wherein the amounts of time comprise (i) a first amount of time between a first previous service event of the first service event type that was scheduled for the user and a second previous service event of the first service event type that was scheduled for the user and (ii) a second amount of time between the second previous service event and a third previous service event of the first service event type that was scheduled for the user;
determine a time interval between service events of the first service event type based on (i) the first amount of time and (ii) the second amount of time;
predict a need for a first service event of the first service event type for the user based on (i) the time interval and (ii) at least one of a date of a previous service event of the first service event type that was scheduled for the user or a time of the previous service event;
determine scheduling information for the first service event based on a first calendar associated with the user and a second calendar associated with a vendor that provides service events of the first service event type, wherein the scheduling information comprises at least one of a first date for the first service event or a first time for the first service event;
determine a reservation for the first service event based on the need prediction and the scheduling information;
provide, to the user, a request to accept the reservation; and
provide, based on the user accepting the reservation, a confirmation of the reservation to the user and the vendor.

2. The system of claim 1, wherein providing the confirmation comprises adding information about the reservation to the first calendar and the second calendar.

3. The system of claim 1, wherein determining the time interval comprises determining an average amount of time between previous service events of the first service event type that were scheduled for the user based on the first amount of time and the second amount of time, and
wherein predicting the need comprises predicting the need for the first service event for the user based on (i) the average amount of time and (ii) at least one of the date of the previous service event or the time of the previous service event.

4. The system of claim 1, wherein the first calendar indicates a set of vendors that provided one or more previous service events for the user, and wherein the one or more physical processors are further cause to:
select the vendor to provide the service event for the user based on the set of vendors and feedback of the user regarding the one or more previous service events.

5. The system of claim 1, wherein the one or more physical processors are further caused to:
predict a second need for a first group service event of a second service event type for a group of users;
determine second scheduling information for the first group service event, wherein the scheduling information comprises at least one of a date for the first group service event or a time for the first group service event;
determine a second reservation for the first group service event based on the second need prediction and the second scheduling information;
provide, to respective users of the user group, a request to accept the second reservation;
provide, based on a first user of the user group accepting the second reservation, a notification to other users of the user group regarding the first user accepting the second reservation;
provide, based on a second user of the user group accepting the second reservation, a notification to other users of the user group regarding the second user accepting the second reservation;
determine, after the first and second users have accepted the second reservation, whether a number of users of the user group that has accepted the second reservation satisfies a predetermined threshold number of users; and
provide a confirmation of the second reservation to respective users of the user group and the vendor based a determination that the number of users that has accept the second reservation satisfies the predetermined threshold number of users.

6. The system of claim 1, wherein the one or more physical processors are further caused to:
associate payment information with the reservation; and
execute payment for the first service event based on the payment information.

7. The system of claim 1, wherein the one or more physical processors are further caused to:
select the vendor as a candidate for providing the first service event to the user; and
determine whether a first personnel of the vendor is a personnel preferred by the user for providing a service event to the user,
wherein determining the scheduling information comprises:
determining, based on the first calendar, a plurality of available dates or times of the user for the first service event; and
responsive to the first personnel being responsive to the first personnel being a personnel preferred by the user for providing a service event to the user: (1) determining, based on the second calendar, a plurality of available date or times of the first personnel for providing the first service event to the user; and (2) determining the scheduling information for the first service event based on the plurality of available dates or times of the user and the plurality of available dates or times of the first personnel.

8. The system of claim 7, wherein selecting the vendor comprises selecting, based on the first personnel being a personnel preferred by the user for providing a service event to the user, the vendor as a candidate for providing the first service event to the user.

9. The system of claim 1, wherein the one or more physical processors are further caused to:
receive, from the user, feedback related to the first service event;
associate the feedback with the vendor;
add the vendor to a list of preferred vendors based on the feedback; and
determine a vendor for a next service event of the first service event type from the list of preferred vendors.

10. The system of claim 1, wherein the one or more physical processors are further caused to:
receive, from the user, feedback related to the first service event;
associate the feedback with the vendor; and
remove the vendor from a list of preferred vendors based on the feedback.

11. A method for facilitating booking of service events based on amounts of time between previous service events, the method being implemented in a computer system comprising one or more physical processors executing one or more computer program instructions which, when executed, perform the method, the method comprising:
determining, by the one or more physical processors, amounts of time between previous service events of a first service event type that were scheduled for a user, wherein the amounts of time comprise (i) a first amount of time between a first previous service event of the first service event type that was scheduled for the user and a second previous service event of the first service event type that was scheduled for the user and (ii) a second amount of time between the second previous service event and a third previous service event of the first service event type that was scheduled for the user;
determining, by the one or more physical processors, a time interval between service events of the first service event type based on (i) the first amount of time and (ii) the second amount of time;
predicting, by the one or more physical processors, a need for a first service event of the first service event type for the user based on (i) the time interval and (ii) at least one of a date of a previous service event of the first service event type that was scheduled for the user or a time of the previous service event;
determining, by the one or more physical processors, scheduling information for the first service event based on a first calendar associated with the user and a second calendar associated with a vendor that provides service events of the first service event type, wherein the scheduling information comprises at least one of a first date for the first service event or a first time for the first service event;
determining, by the one or more physical processors, a reservation for the first service event based on the need prediction and the scheduling information;
providing, by the one or more physical processors, to the user, a request to accept the reservation; and
providing, by the one or more physical processors, based on the user accepting the reservation, a confirmation of the reservation to the user and the vendor.

12. The method of claim 11, wherein providing the confirmation comprises adding information about the reservation to the first calendar and the second calendar.

13. The method of claim 11, wherein determining the time interval comprises determining an average amount of time between previous service events of the first service event type that were scheduled for the user based on the first amount of time and the second amount of time, and
wherein predicting the need comprises predicting the need for the first service event for the user based on (i) the average amount of time and (ii) at least one of the date of the previous service event or the time of the previous service event.

14. The method of claim 11, wherein the first calendar indicates a set of vendors that provided one or more previous service events for the user, the method further comprising:
selecting, by the one or more physical processors, the vendor to provide the service event for the user based on the set of vendors and feedback of the user regarding the one or more previous service events.

15. The method of claim 11, further comprising:
predicting, by the one or more physical processors, a second need for a first group service event of a second service event type for a group of users;
determining, by the one or more physical processors, second scheduling information for the first group service event, wherein the scheduling information comprises at least one of a date for the first group service event or a time for the first group service event;
determining, by the one or more physical processors, a second reservation for the first group service event based on the second need prediction and the second scheduling information;
providing, by the one or more physical processors, to respective users of the user group, a request to accept the second reservation;
providing, by the one or more physical processors, based on a first user of the user group accepting the second reservation, a notification to other users of the user group regarding the first user accepting the second reservation;
providing, by the one or more physical processors, based on a second user of the user group accepting the second reservation, a notification to other users of the user group regarding the second user accepting the second reservation;
determining, by the one or more physical processors, after the first and second users have accepted the second reservation, whether a number of users of the user group that has accepted the second reservation satisfies a predetermined threshold number of users; and
providing, by the one or more physical processors, a confirmation of the second reservation to respective users of the user group and the vendor based a determination that the number of users that has accept the second reservation satisfies the predetermined threshold number of users.

16. The method of claim 11, further comprising:
associating, by the one or more physical processors, payment information with the reservation; and
executing, by the one or more physical processors, payment for the first service event based on the payment information.

17. The method of claim 11, further comprising:
selecting, by the one or more physical processors, the vendor as a candidate for providing the first service event to the user; and
determining, by the one or more physical processors, whether a first personnel of the vendor is a personnel preferred by the user for providing a service event to the user,
wherein determining the scheduling information comprises:
determining, based on the first calendar, a plurality of available dates or times of the user for the first service event; and
responsive to the first personnel being responsive to the first personnel being a personnel preferred by the user for providing a service event to the user: (1) determining, based on the second calendar, a plurality of available date or times of the first personnel for providing the first service event to the user; and (2) determining the scheduling information for the first service event based on the plurality of available dates or times of the user and the plurality of available dates or times of the first personnel.

18. The method of claim 17, wherein selecting the vendor comprises selecting, based on the first personnel being a personnel preferred by the user for providing a service event to the user, the vendor as a candidate for providing the first service event to the user.

19. The method of claim 11, further comprising:
receiving, at the one or more physical processors, from the user, feedback related to the first service event;
associating, by the one or more physical processors, the feedback with the vendor;
adding, by the one or more physical processors, the vendor to a list of preferred vendors based on the feedback; and
determining, by the one or more physical processors, a vendor for a next service event of the first service event type from the list of preferred vendors.

20. The method of claim 11, further comprising:
receiving, at the one or more physical processors, from the user, feedback related to the first service event;
associating, by the one or more physical processors, the feedback with the vendor; and
removing, by the one or more physical processors, the vendor from a list of preferred vendors based on the feedback.

21-30. (canceled)
